(19) United States
(12) Patent Application Publication
(10) Pub. No.: US 2026/0155002 A1
(43) Pub. Date: Jun. 4, 2026

(54) DYNAMIC QR CODE FOR VEHICLE DIAGNOSTICS

(71) Applicant: Innova Electronics Corporation, Irvine, CA (US)

(72) Inventors: David RICH, Huntington Beach, CA (US); Hoa CHAU, Irvine, CA (US); Wendy SENT, Dana Point, CA (US)

(21) Appl. No.: 19/409,109

(22) Filed: Dec. 4, 2025

Related U.S. Application Data
(63) Continuation-in-part of application No. 18/990,596, filed on Dec. 20, 2024.
(60) Provisional application No. 63/727,086, filed on Dec. 2, 2024.

(51) Int. Cl. G07C 5/08; G06F 16/955; G06K 7/14; G07C 5/00

(52) U.S. Cl. CPC G07C 5/0825; G06F 16/955; G06K 7/1417; G07C 5/008; G07C 5/0808; G07C 2205/02

(57) ABSTRACT

A method of enabling continued access to a vehicle-specific diagnostic data package includes receiving a vehicle diagnostic data package generated from a scan of a specific vehicle at a first location, appending a unique identifier to the diagnostic data package, communicating the diagnostic data package with the appended unique identifier to one or more servers where the diagnostic data package can be stored at a location indexable by the unique identifier, and producing a copy of a diagnostic report generated by the server(s). The copy of the diagnostic report may include a barcode (e.g., QR code) representative of the location where the diagnostic data package is stored on the server(s) and further representative of at least one provider of automotive parts or repair services. The barcode may be scannable by a handheld computing device to enable access to the diagnostic data package and identification of the at least one provider.

### CROSS-REFERENCE TO RELATED APPLICATIONS

This application is a continuation-in-part of U.S. Patent Application Serial No. 18/990,596, filed December 20, 2024, and entitled “DYNAMIC QR CODE FOR VEHICLE DIAGNOSTICS,” which claims priority to U.S. Provisional Application Serial No. 63/727,086, filed December 2, 2024, the entire contents of each of which is incorporated by reference herein.

### STATEMENT RE: FEDERALLY SPONSORED RESEARCH/DEVELOPMENT

Not Applicable

### BACKGROUND

In order to incorporate state-of-the-art vehicle diagnostic technology, automotive service centers and parts stores provide their customers with the use of automotive scan tools to collect on-board diagnostic data (OBD-II data) from their vehicles. The scan tools, which may be handled by an employee of the service center or parts store or by the customer him/herself, are plugged into the vehicle in question to retrieve a diagnostic data package. Afterward, the scan tool is brought to an on-site computer to produce a diagnostic report, which is usually printed out on paper for the customer. In reality, the generation of the diagnostic report is a complex task that may make use of proprietary algorithms and databases belonging to another entity that acts as a diagnostic service provider. Depending on the particular arrangement between the diagnostic service provider and the service center or parts store, the on-site computer may produce the diagnostic report through communication with a local or remote server belonging to the diagnostic service provider, for example.

From the perspective of the service center or parts store, the arrangement makes it possible to provide a diagnostic scan service to its customers. The resulting diagnostic report beneficially directs the customers to purchase services or parts offered by the store. In addition, the customer is happy because the diagnostic report empowers him/her to make educated choices about the needed repairs, rather than relying entirely on the opinion of a store employee. The customer may even decide to attempt the repairs him/herself, which is still beneficial to the store to the extent that parts are needed and may be conveniently referenced in the diagnostic report.

Unfortunately, the value of the diagnostic report diminishes over time, both to the customer and to the store. This is because the diagnostic report is based on the diagnostic data package that was collected at one snapshot in time. Days or weeks later, based only on the diagnostic report and not the underlying diagnostic data itself, it may be difficult to make reliable judgments about servicing the vehicle. For example, it may be the case that the diagnostic report contains one, but not all, possible vehicle conditions that are derivable from the diagnostic data package. From the standpoint of the customer, there is no possibility of obtaining a second opinion in this instance because the diagnostic report does not contain all of the underlying data. Moreover, the scan that was done is essentially wasted when it comes to other potential uses of the captured diagnostic data package. It would be far more efficient for the scan results themselves to be portable, allowing the vehicle owner to use them for any number of purposes, such as for state emissions testing, for an insurance claim, for a police report involving the functioning of the vehicle, or in connection with resale of the vehicle. The best that a vehicle owner can do given existing technological constraints is to make use of a vehicle diagnostics mobile application (“app”) that interfaces with the vehicle owner’s own scan tool. The app may allow the vehicle owner to save past scans, thereby keeping a record of the underlying diagnostic data that was retrieved from the vehicle. However, even with such an app, there is no way for the user to access the data of past third-party scans such as those performed at a service center or parts store.

### BRIEF SUMMARY

The present disclosure contemplates various systems and methods for overcoming the above drawbacks accompanying the related art. A vehicle owner or other customer of an automotive service center or parts store may request a scan of his/her vehicle using a diagnostic tool provided by the store. The retrieved diagnostic data package (also referred to as the vehicle payload) may be uploaded to a computer at the store, which may communicate with one or more local or remote servers of a diagnostic service provider that derive a diagnostic report based on the diagnostic data package. Advantageously, the store computer may associate a unique identifier with the diagnostic data package, which is then provided to the server(s) together with the diagnostic data package. The server(s) may use the unique identifier to index the diagnostic data package for later retrieval. Meanwhile, when the store computer produces a printed copy of the diagnostic report for the customer, the same unique identifier may be included in the report, preferably in the form of a readily scannable code such as a QR code or other barcode that may be scanned by a smartphone camera. By scanning the code, the vehicle owner or other interest holder (e.g., auto mechanic, insurance company, state emissions tester, etc.) may access the server(s) of the diagnostic service provider to retrieve the same diagnostic data package that was the basis for the diagnostic report or to request a different diagnostic report that is derived from the same diagnostic data package but is customized for that particular user’s application. For instance, upon scanning the code, an app that is designed for a professional auto mechanic may request a different (e.g., more detailed) version of the report than an app that is designed for a vehicle owner. Any number of additional features may be provided as part of a customized report, including detailed part information, technical videos on how to perform a repair, AI-assisted step-by-step guidance, etc.

Owing to the use of the unique identifier, which may be both stored on the server(s) in association with the diagnostic data package and encoded within the diagnostic report (e.g., as a QR code), the disclosed subject matter may effectively enable the use of two distinct pathways for deriving diagnostic reports from the same underlying diagnostic data. The first is the service center or parts store’s local computer communicating the diagnostic data package to the server(s) and directly receiving the diagnostic report therefrom at the time and location of the scan of a customer’s vehicle. The second pathway is the later access of the same diagnostic data package on the server(s) by the customer or by another user by scanning the encoded unique identifier on the report. By enabling this second pathway for locating the same diagnostic data package, the disclosed subject matter may allow for unlimited flexibility in regard to customized diagnostic reports and other beneficial uses of the scan, even those occurring at later times and different locations relative to the scan. Significantly, the service center or parts store itself may provide an app to its customers in order to take advantage of this second pathway. After the customer leaves the store and has had time to mull over the initial diagnostic report, the customer may scan the QR code to request additional information or any number of customized reports. Advantageously, from the store’s perspective, a scan performed by the store’s own app may point the customer back to the store (or to another location of the same store, depending on the customer’s current location) for needed service or parts. In this way, service centers and parts stores may encourage return business while simultaneously empowering customers with increased functionality at their fingertips and enabling powerful new features and beneficial uses of their diagnostic scans.

One aspect of the embodiments of the present disclosure is a method of enabling continued access to a vehicle-specific diagnostic data package after a diagnostic report is generated using the diagnostic data package. The process may comprise receiving a vehicle diagnostic data package generated from a scan of a specific vehicle at a first location, appending a unique identifier to the diagnostic data package, and communicating the diagnostic data package with the appended unique identifier (e.g., via a first pathway) to one or more servers where the diagnostic data package can be stored at a location indexable by the unique identifier. The one or more servers may be configured to process the diagnostic data package to generate a diagnostic report identifying vehicle conditions associated with the specific vehicle and the received diagnostic data package. The method may further comprise producing a printed copy of the diagnostic report at the first location. The printed copy of the diagnostic report may include a barcode representative of the location where the diagnostic data package is stored on the one or more servers. The barcode may be scannable by a handheld computing device to enable later access to the diagnostic data package (e.g., via a second pathway distinct from the first) at a date after the scan occurred and at a place remote from the first location.

Another aspect of the embodiments of the present disclosure is a computer program product comprising one or more non-transitory program storage media on which are stored instructions executable by one or more processors or programmable circuits to perform operations for enabling continued access to a vehicle-specific diagnostic data package after a diagnostic report is generated using the diagnostic data package. The operations may comprise receiving a vehicle diagnostic data package generated from a scan of a specific vehicle at a first location, appending a unique identifier to the diagnostic data package, and communicating the diagnostic data package with the appended unique identifier to one or more servers where the diagnostic data package can be stored at a location indexable by the unique identifier. The one or more servers may be configured to process the diagnostic data package to generate a diagnostic report identifying vehicle conditions associated with the specific vehicle and the received diagnostic data package. The operations may further comprise producing a printed copy of the diagnostic report at the first location. The printed copy of the diagnostic report may include a barcode representative of the location where the diagnostic data package is stored on the one or more servers. The barcode may be scannable by a handheld computing device to enable later access to the diagnostic data package (e.g., via a second pathway distinct from the first) at a date after the scan occurred and at a place remote from the first location.

Another aspect of the embodiments of the present disclosure is a system for enabling continued access to a vehicle-specific diagnostic data package after a diagnostic report is generated using the diagnostic data package. The system may comprise a computer configured to receive a vehicle diagnostic data package generated from a scan of a specific vehicle at a first location, append a unique identifier to the diagnostic data package, communicate the diagnostic data package with the appended unique identifier (e.g., via a first pathway) to one or more servers where the diagnostic data package can be stored at a location indexable by the unique identifier, and produce a printed copy of a diagnostic report at the first location, the diagnostic report being generated by the one or more servers based on the diagnostic data package and identifying vehicle conditions associated with the specific vehicle. The system may further comprise a handheld computing device configured to scan a barcode (e.g. QR or other two-dimensional barcode) included in the printed copy of the diagnostic report and representative of the location where the diagnostic data package is stored on the one or more servers, the barcode being scannable by the handheld computing device to enable later access to the diagnostic data package (e.g., via a second pathway distinct from the first) at a date after the scan occurred and at a place remote from the first location.

Another aspect of the embodiments of the present disclosure is a method of enabling continued access to a vehicle-specific diagnostic data package after a diagnostic report is generated using the diagnostic data package. The process may comprise receiving a vehicle diagnostic data package generated from a scan of a specific vehicle at a first location, appending a unique identifier to the diagnostic data package, and communicating the diagnostic data package with the appended unique identifier (e.g., via a first pathway) to one or more servers where the diagnostic data package can be stored at a location indexable by the unique identifier. The one or more servers may be configured to process the diagnostic data package to generate a diagnostic report identifying vehicle conditions associated with the specific vehicle and the received diagnostic data package. The method may further comprise producing a copy of the diagnostic report at the first location. The copy of the diagnostic report may include a barcode representative of the location where the diagnostic data package is stored on the one or more servers and further representative of at least one provider of automotive parts or repair services identified in the diagnostic report. The barcode may be scannable by a handheld computing device to enable access to the diagnostic data package (e.g., via a second pathway distinct from the first) and identification of the at least one provider.

Another aspect of the embodiments of the present disclosure is a computer program product comprising one or more non-transitory program storage media on which are stored instructions executable by one or more processors or programmable circuits to perform operations for enabling continued access to a vehicle-specific diagnostic data package after a diagnostic report is generated using the diagnostic data package. The operations may comprise receiving a vehicle diagnostic data package generated from a scan of a specific vehicle at a first location, appending a unique identifier to the diagnostic data package, and communicating the diagnostic data package with the appended unique identifier to one or more servers where the diagnostic data package can be stored at a location indexable by the unique identifier. The one or more servers may be configured to process the diagnostic data package to generate a diagnostic report identifying vehicle conditions associated with the specific vehicle and the received diagnostic data package. The operations may further comprise producing a copy of the diagnostic report at the first location. The copy of the diagnostic report may include a barcode representative of the location where the diagnostic data package is stored on the one or more servers and further representative of at least one provider of automotive parts or repair services identified in the diagnostic report. The barcode may be scannable by a handheld computing device to enable access to the diagnostic data package (e.g., via a second pathway distinct from the first) and identification of the at least one provider.

Another aspect of the embodiments of the present disclosure is a system for enabling continued access to a vehicle-specific diagnostic data package after a diagnostic report is generated using the diagnostic data package. The system may comprise a computer configured to receive a vehicle diagnostic data package generated from a scan of a specific vehicle at a first location, append a unique identifier to the diagnostic data package, communicate the diagnostic data package with the appended unique identifier (e.g., via a first pathway) to one or more servers where the diagnostic data package can be stored at a location indexable by the unique identifier, and produce a copy of a diagnostic report at the first location, the diagnostic report being generated by the one or more servers based on the diagnostic data package and identifying vehicle conditions associated with the specific vehicle. The system may further comprise a handheld computing device configured to scan a barcode (e.g. QR or other two-dimensional barcode) included in the copy of the diagnostic report. The barcode may be representative of the location where the diagnostic data package is stored on the one or more servers and further representative of at least one provider of automotive parts or repair services identified in the diagnostic report. The barcode may be scannable by the handheld computing device to enable access to the diagnostic data package (e.g., via a second pathway distinct from the first) and identification of the at least one provider.

In any of the above aspects, the barcode may include indicia representative of the unique identifier. Upon accessing the diagnostic data package on the one or more servers using the handheld computing device, a user may direct the one or more servers to regenerate the diagnostic report, to identify parts needed to address vehicle conditions in the diagnostic report, and/or to generate a customized diagnostic report. The customized diagnostic report may be customized based on environmental data associated with the handheld computing device, which may include a time or date at which the diagnostic data package is accessed using the handheld computing device, a location at which the diagnostic data package is accessed using the handheld computing device, an identity of a mobile application installed on the handheld computing device, an identity of the user (e.g., user type), a skill level of the user, and/or a user preference. The one or more servers may comprise a remote server at a location remote from the first location. In this case, the diagnostic data package and appended unique identifier may be communicated to the remote server via the Internet. Alternatively, or additionally, the one or more servers may comprise a local server at the first location.

Another aspect of the embodiments of the present disclosure is a system for providing customized vehicle diagnostics. The system may comprise a diagnostic tool operable to retrieve a vehicle payload from a vehicle, the vehicle payload including onboard diagnostic data of the vehicle. The system may further comprise a computer operable to receive the vehicle payload from the diagnostic tool and associate a unique identifier with the vehicle payload and a black box unit in communication with the computer, the black box unit including one or more processors configured to receive the vehicle payload and the associated unique identifier from the computer and to derive a first diagnostic report based on the vehicle payload with reference to a secret database of historical diagnostic data that is inaccessible to the computer. The system may further comprise one or more servers in communication with the black box unit, the one or more servers being configured to receive the vehicle payload and the associated unique identifier from the black box unit. The computer may be further operable to receive the first diagnostic report from the black box unit and to produce a printed report based on the first diagnostic report, the printed report including a QR code encoding the unique identifier. The one or more servers may be further configured to receive the unique identifier from a mobile communication device in response to a scan of the QR code by the mobile communication device, match the unique identifier to the associated vehicle payload, and derive a second diagnostic report based on the vehicle payload, the second diagnostic report being customized for a user of the mobile communication device.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows a system for enabling continued access to a vehicle-specific diagnostic data package according to one or more embodiments of the present disclosure;

FIG. 2 shows an example operational flow of the system;

FIG. 3A shows an example webpage generated by the system; and

FIG. 3B shows another example webpage generated by the system.

### DETAILED DESCRIPTION

The present disclosure encompasses various embodiments of systems and methods for enabling continued access to a vehicle-specific diagnostic data package after a diagnostic report is remotely generated using the diagnostic data package. The detailed description set forth below in connection with the appended drawings is intended as a description of several currently contemplated embodiments and is not intended to represent the only form in which the disclosed invention may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

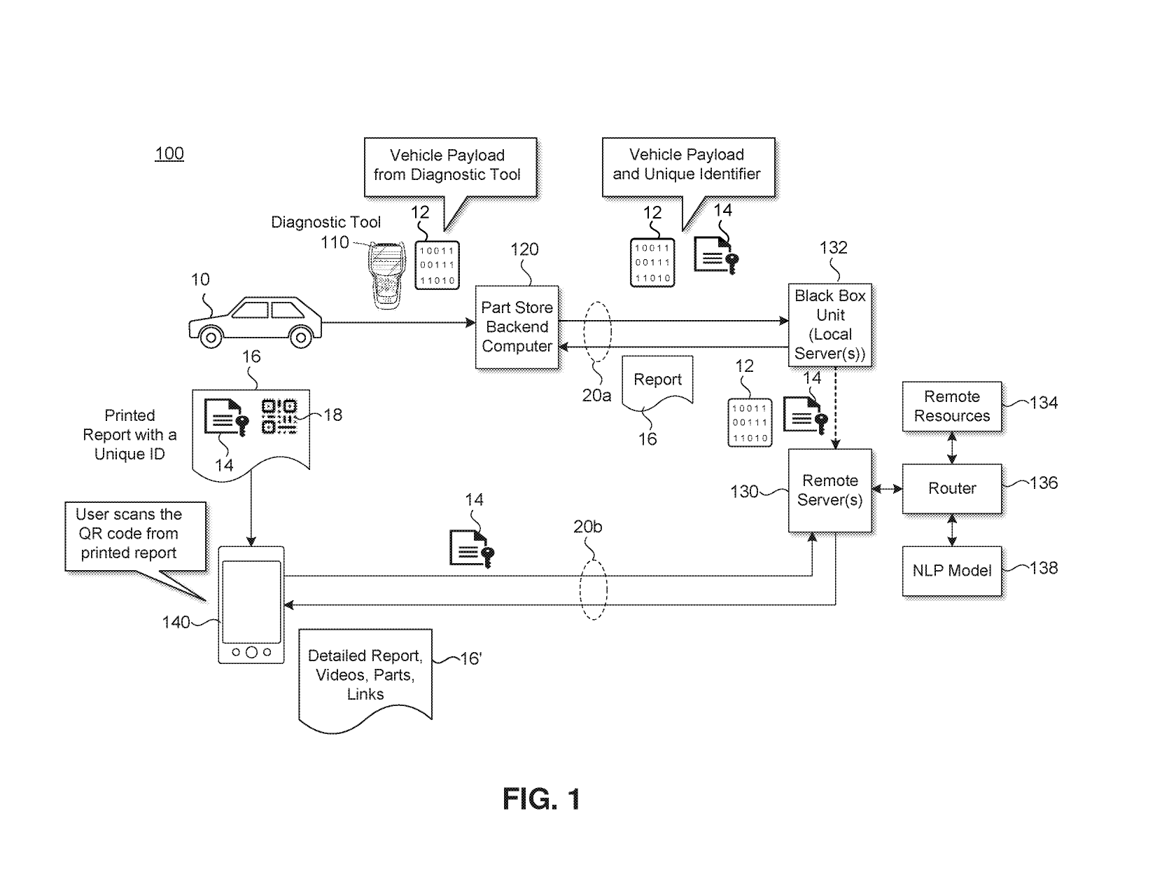

FIG. 1 shows a system 100 according to one or more embodiments of the present disclosure. The system 100 may reside, at least in part, in a retail setting such as an automotive service center or parts store where a vehicle 10 may be scanned using a diagnostic tool 110. Typically located in the same retail setting, the system 100 may include a part store backend computer 120, which may or may not be in communication with a point of sale. Depending on the particular commercial implementation of the disclosed subject matter, the system 100 may additionally or alternatively encompass one or more remote server(s) 130 of a diagnostic service provider that is remote from the retail setting and may be controlled by a separate entity. Along the same lines, the system 100 may additionally or alternatively encompass a provider of a mobile application (“app”) that is installable on a mobile communication device (e.g., a smartphone or tablet) or other handheld computing device 140, or in some cases a provider of the handheld computing device 140 itself. In the case of an app, for example, the app may be provided by the same retail store, by the same diagnostic service provider, or by a separate entity.

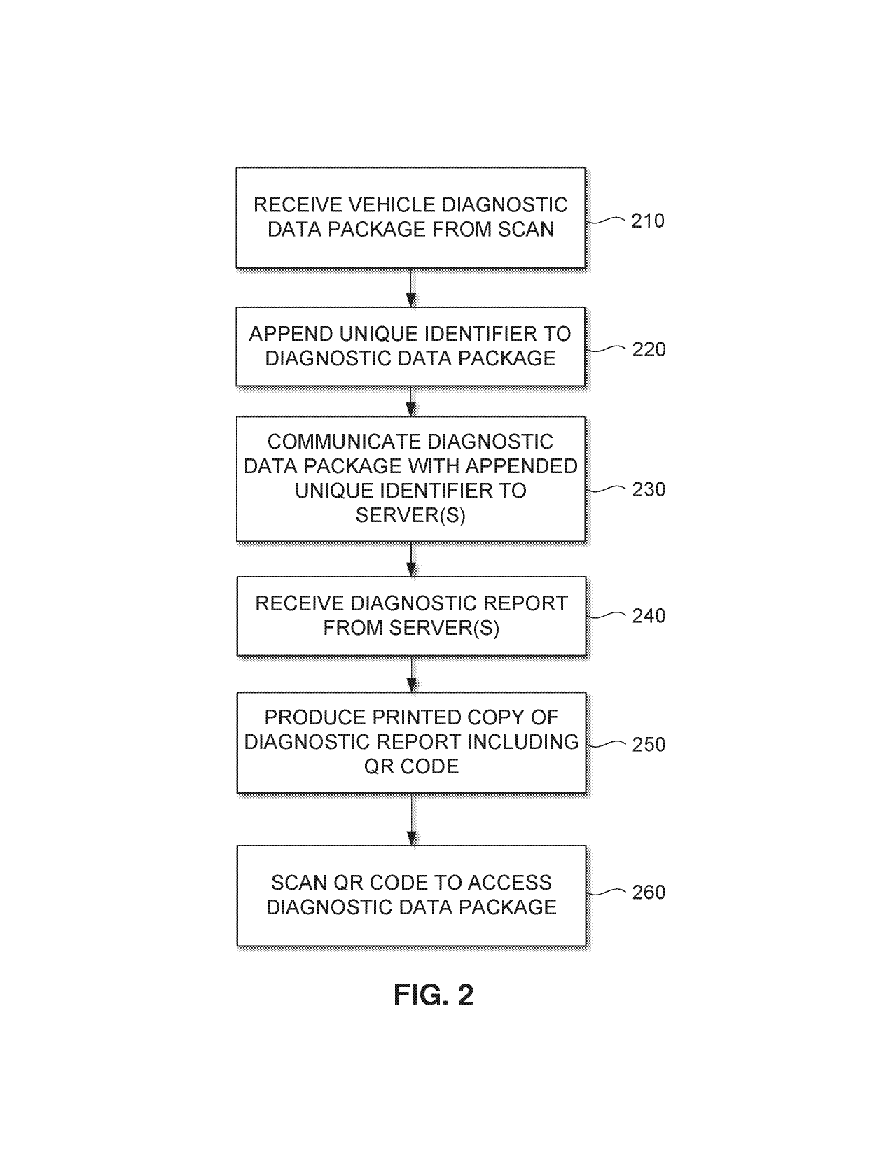

Referring to FIG. 2 together with FIG. 1, an operational flow of the system 100 may begin at a part store or other retail establishment that offers a diagnostic scan service. The store may, for example, provide a diagnostic tool 110 for use by its customers. The diagnostic tool 110 may be a scan tool or dongle that is operable to retrieve a vehicle payload or diagnostic data package 12 from a vehicle 10 by connecting to a data port of the vehicle 10 and collecting onboard diagnostic data (OBD-II data) from the vehicle’s electronic control unit (ECU). After scanning his/her vehicle 10, the customer may hand the diagnostic tool 110 back to an employee of the store who may upload the diagnostic data package 12 to the store’s backend computer 120. The computer 120 may thus receive the diagnostic data package 12 corresponding to specific scan (e.g., performed at that time and location) of a specific vehicle 10 (step 210 of FIG. 2). The diagnostic data package 12 may include OBD-II diagnostic trouble codes (DTCs), live sensor data, and freeze frame data, as well as OEM-specific data (codes, live data, etc.). The diagnostic data package 12 may further include a vehicle identification number (VIN) of the vehicle 10, which may be used to derive the specific make, model, year, and engine of the vehicle 10 for purposes of diagnostic analysis including interpretation of OEM-specific data.

The operational flow may continue with the computer 120 appending a unique identifier 14 to the diagnostic data package 12 (step 220). The computer 120 may generate the unique identifier 14 as a hash of the diagnostic data, for example, and may associate the unique identifier 14 with the diagnostic data package 12 according to a one-to-one correspondence. The computer 120 may then communicate the diagnostic data package 12 with the appended unique identifier 14 (and any other information such as a date or store identifier) to one or more servers 130, 132 (step 230). In the illustrated example, both remote server(s) 130 and a local server identified as a black box unit 132 are shown. In this implementation, a third-party diagnostic service provider may provide a black box unit 132 as a local server that may perform diagnostic analysis on the diagnostic data package 12. The black box unit 132 may be in communication with the computer 120 (e.g., locally without requiring an Internet connection) and may include one or more processors configured to derive a diagnostic report 16 based on the diagnostic data package 12, with reference to a secret database of historical diagnostic data that is inaccessible to the store computer 120 (e.g., in order to keep the diagnostic service provider’s proprietary data and methodology secret). The diagnostic report 16 may identify vehicle conditions associated with the specific vehicle 10 and the received diagnostic data package 12 that was retrieved at the store by the diagnostic tool 110. In addition to providing the diagnostic report 16 back to the store computer 120, the black box unit 132 may provide the underlying diagnostic data package 12 with appended unique identifier 14 to one or more remote servers 130, typically also controlled by the diagnostic service provider.

As described above, a black box unit 132 may be used for convenience of the store (e.g., for security or to enable diagnostic analysis without access to the Internet or while isolating the store computer 120 from Internet hacks). Alternatively, the black box unit 132 may be omitted and the store computer 120 may communicate directly with the remote server(s) 130, uploading the diagnostic data package 12 and appended unique identifier 14 thereto (e.g., over the Internet) and receiving the diagnostic report 16 in response. The communication of the store computer 120 with either the black box unit 132 or the remote server(s) 130 to get the diagnostic report 16 represents a first pathway 20a. In either case, the remote server(s) 130 may store a copy of the diagnostic data package 12 at a location indexable by the unique identifier 14. The remote server(s) 130 may be configured to process the diagnostic data package 12 to generate the same or a different diagnostic report 16 according to a later request received from a handheld computing device 140 at a time and/or location that is different from that of the original scan at the store. The communication of the handheld computing device 140 with the remote server(s) 130 to again access the same underlying diagnostic data package 12 and get this further report (as described in more detail below) represents a second pathway 20b that is distinct from the first pathway 20a. It is contemplated that the second pathway 20b can be implemented anywhere and anytime, without tying up the resources of the first pathway 20a. A user can download the full report 16 and/or download an app that enables additional functionalities as well.

To produce the diagnostic report 16, the one or more servers 130, 132 may derive a diagnostic condition of the vehicle 10 from the uploaded diagnostic data package by comparing the uploaded diagnostic data with data (e.g., historical data) stored in one or more diagnostic databases. The diagnostic condition of the vehicle 10 may include, for example, information about the root cause of a problem that the vehicle 10 is exhibiting and/or an indication of one or more repair solutions or replacement parts for addressing the problem. Exemplary diagnostic methods, including the use of such diagnostic data to arrive at a most likely root cause and repair solution as well as vehicle-specific replacement parts, and in some cases the inclusion of a diagnostic router, are described in the following U.S. patent documents, each of which is owned by Innova Electronics Corporation of Irvine, California: U.S. Patent No. 6,807,469, entitled AUTO DIAGNOSTIC METHOD AND DEVICE, U.S. Patent No. 6,925,368, entitled AUTO DIAGNOSTIC METHOD AND DEVICE, U.S. Patent No. 7,620,484, entitled AUTOMOTIVE MOBILE DIAGNOSTICS, U.S. Patent No. 8,068,951, entitled VEHICLE DIAGNOSTIC SYSTEM, U.S. Patent No. 8,019,503, entitled AUTOMOTIVE DIAGNOSTIC AND REMEDIAL PROCESS, U.S. Patent No. 8,370,018, entitled AUTOMOTIVE DIAGNOSTIC PROCESS, U.S. Patent No. 8,909,416, entitled HANDHELD SCAN TOOL WITH FIXED SOLUTION CAPABILITY, U.S. Patent No. 9,014,908, entitled MULTI-STAGE DIAGNOSTIC SYSTEM AND METHOD, U.S. Patent No. 9,142,066, entitled MULTI-STAGE DIAGNOSTIC SYSTEM AND METHOD, U.S. Patent No. 9,026,400, entitled DIAGNOSTIC PROCESS FOR HOME ELECTRONIC DEVICES, U.S. Patent No. 9,177,428, entitled PREDICTIVE DIAGNOSTIC METHOD, U.S. Patent No. 9,646,432, entitled HAND HELD DATA RETRIEVAL DEVICE WITH FIXED SOLUTION CAPABILITY, U.S. Patent No. 9,824,507, entitled MOBILE DEVICE BASED VEHICLE DIAGNOSTIC SYSTEM, U.S. Patent No. 10,643,403, entitled PREDICTIVE DIAGNOSTIC METHOD AND SYSTEM, U.S. Patent No. 11,068,560, entitled METHOD OF PROCESSING VEHICLE DIAGNOSTIC DATA, U.S. Patent No. 11,270,529, entitled SYSTEM AND METHOD FOR PROACTIVE VEHICLE DIAGNOSIS AND OPERATIONAL ALERT, U.S. Patent No. 11,158,141, entitled SYSTEM AND METHOD FOR PROACTIVE VEHICLE DIAGNOSIS AND OPERATIONAL ALERT, and U.S. Patent No. 11,651,628, entitled ROUTER FOR VEHICLE DIAGNOSTIC SYSTEM, the entire contents of each of which is expressly incorporated by reference herein.

After receiving the diagnostic report 16 from the server(s) 130, 132 (step 240), the store computer 120 may produce a printed copy of the diagnostic report 16 (step 250), which may be handed to the customer at the store. Advantageously, the printed copy may include a barcode 18 (e.g., a two-dimensional barcode such as a QR code) that is representative of the location where the diagnostic data package 12 is stored by the one or more servers 130. For example, the barcode 18 may encode or otherwise include indicia representative of the same hash or other unique identifier 14 that was appended to the diagnostic data package 12 by the computer 120 and used by the server(s) 130 to index the diagnostic data package 12. The unique identifier 14 may or may not also be included in the report 16 in unencoded form (e.g., as a many-digit number) separate from the barcode 18. The barcode 18 may be scannable by the handheld computing device 140 to enable later access to the diagnostic data package 12 at a date after the scan occurred and at a place remote from the store where the scan was performed (step 260). In response to a scan of the barcode 18 by the handheld computing device 140, the remote server(s) 130 may match the unique identifier 14 encoded in the barcode 18 to the associated diagnostic data package 12 and provide additional functionality based thereon such as deriving a new diagnostic report 16’ that may be customized for the user of the handheld computing device 140 (e.g., detailed report, videos, parts, links, etc.).

In a basic implementation, the user, who was a customer of the parts store or other retail store described above, may scan the barcode 18 to regenerate the same diagnostic report 16 (in which case the diagnostic report 16’ shown in FIG. 1 is the same as the diagnostic report 16). For example, the user may only have a paper copy but may wish to have a digital copy of the same report 16 that cannot be damaged or misplaced. For such a purpose, the barcode 18 may direct the user’s web browser to a download page to download a digital copy of the report 16' from the server(s) 130. The barcode 18 may, for example, encode a URL of a website for downloading the report 16 and may encode the unique identifier 14 as a query string of the URL. In this way, upon accessing the diagnostic data package 12 on the server(s) 130 using the handheld computing device 140, the user may direct the server(s) 130 to regenerate the diagnostic report 16.

It is contemplated that the regenerated report 16 may include additional details and features (and may thus be referenced as a report 16’ in FIG. 1 to distinguish from the report 16), such as identification or parts needed to address vehicle conditions in the diagnostic report 16, links to part stores and service providers, instructional videos and images to assist with replacing parts and performing other repairs, etc. Such features may be included by default or, preferably, may depend on the identity of the user or the identity of the app that is being used to scan the barcode 18. In this regard, it is contemplated that the barcode 18 may be scanned by an app installed on the user’s handheld computing device 140 (rather than by the native camera app, for example), and the app may provide additional information to the server(s) 130 along with the content of the barcode 18 itself. In this way, a user of the handheld computing device 140 may direct the server(s) 130 to generate a customized diagnostic report.

A customized diagnostic report 16’ as contemplated herein may be customized based on environmental data associated with the handheld computing device 140, such as a time or date at which the diagnostic data package 12 stored by the server(s) 130 is being accessed or a contemporaneous location (e.g., a geolocation) of the handheld computing device 140. Time, date, and location information may be used by the server(s) 130 to determine a nearby available parts store to the user, for example, which can be included in the customized diagnostic report 16’. Upon scanning the barcode 18, the user may be directed within the app to a digital copy of the diagnostic report 16’ that includes “next steps” tailored for the user’s current time and location (e.g., “You still have time to purchase the necessary parts to replace your mass flow sensor today at this location, which closes in two hours,” with a map showing the location of a store and directions). In a case where the app is provided by a retailer such as a parts store, the retailer’s own locations may be prioritized. Alternatively, or additionally, the user may be able to select a preferred retailer, which may be included with the request sent to the server(s) 130 so that the server(s) 130 can correctly customize the diagnostic report 16’ according to the user’s preferences.

When the identity of the app and/or the identity of the user is included as environmental data to be provided to the server(s) 130 upon scanning the barcode 18, the system 100 makes it possible to use the stored diagnostic data package 12 for many different purposes. For example, an app for individuals and do-it-yourselfers (DIYers) may request from the server(s) 130 a simpler report 16’ in comparison to an app that is designed for professional auto mechanics (which might assume basic knowledge of vehicle parts terminology). Along the same lines, the app may include a skill level of the user and/or user preferences that inform the server(s) 130 on how to appropriately tailor the complexity of the diagnostic report 16’. In some cases, the server(s) 130 may support guided and/or AI-assisted diagnostic testing of a derived diagnostic condition or solution, in a manner as set forth in U.S. Patent No. 11,915,534, entitled VEHICLE DIAGNOSTICS WITH INTELLIGENT COMMUNICATION INTERFACE, U.S. Patent No. 12,112,587, entitled SYSTEM AND METHOD FOR GUIDED VEHICLE DIAGNOSTICS and/or U.S. Patent Application No. 18/910,795, entitled ARTIFICIAL INTELLIGENCE ASSISTANT FOR VEHICLE DIAGNOSTICS, filed October 9, 2024, both owned by Innova Electronics Corporation of Irvine, California, the entire contents of each of which is expressly incorporated by reference. In general, the user may access various remote resources 134 via the server(s) 130, which may connect to the requested resources 134 via a router 136 according to the particular request including the identity of the app and/or user, user preferences, or other environmental data. Among such remote resources 134 may be one or more NLP models 138 that may be used to allow the user to make requests and communicate with the server(s) 130 using natural spoken (or text) language.

The contemplated purposes are not limited to vehicle repairs and replacing parts. For example, a state emissions testing authority may have an app for collecting and evaluating diagnostic data to determine emissions testing compliance. If a vehicle owner has already conducted a scan at a parts store or other retailer as described above, the same diagnostic data package 12 may be reviewed for emissions testing compliance simply by scanning the barcode 18 in the user’s original report 16. In response to the scan of the barcode 18 by the app, the server(s) 130 may provide the data in a form suitable for the emissions testing authority, including information about when the diagnostic data package 12 was retrieved from the vehicle 10 (which may have to be relatively recent in order to be usable in accordance with state law). As another example, a seller of used vehicles may provide an app to its potential buyers and may post the barcodes 18 in the windows of vehicles that are for sale on the seller’s lot. When a potential buyer scans a barcode 18 using the app, the server(s) 130 may generate a report 16’ based on the diagnostic data package 12 highlighting information that may be useful to the buyer, such as mileage, most recent vehicle condition (on the particular date that the diagnostic data package 12 was collected), valuation of the vehicle 10, etc. Apps for police/investigators, insurance companies/customers, vehicle OEMs, vehicle brokers, or any other entities may likewise make use of the previously collected diagnostic data package 12 in completely different ways, with the same barcode 18 dynamically directing the app to differently customized reports 16’ and functions based on the same stored diagnostic data package 12.

As explained above, a preferred retailer may be associated with the report 16’ that is generated in response to the scanning of the barcode 18. This may be accomplished by preconfiguring the app that is used to scan the barcode 18. For example, in a case where the app that scans the barcode 18 is provided by a retailer such as a parts store, the app may include the identity of the retailer in the request to the server(s) 130. A user-preferred retailer may be included with the request in the same way, namely, by inclusion of the preference data in the request that is sent to the server(s) 130. An alternative to this app-driven approach is to include retailer data in the barcode 18 itself. For example, after receiving the diagnostic report 16 from the server(s) 130, 132 (step 240 in FIG. 2), the store computer 120 may produce a printed copy of the diagnostic report 16 (step 250), which may be handed to the customer at the store and may include the barcode 18 including indicia representative of the unique identifier 14 as described above. So as not to lose the customer to a competitor parts store or service center, the store may additionally encode preferred retailer data in the same barcode 18. When the barcode 18 is later scanned by the handheld computing device 140, the preferred retailer data (which may be included in a query string of an encoded URL, for example) may be uploaded to the remote server(s) 130 and used to tailor the diagnostic report 16’ according to the preferences and business objectives of the store where the scan was performed. In this way, the barcode 18 may be used to drive the customer back to the same store or affiliated business (e.g., distributor) for the purchase of parts or repair of the vehicle.

The identity of the user, such as a customer ID, may similarly be encoded in the barcode itself (e.g., as a query string of a URL). In this way, when the barcode 18 is scanned, the customer ID may be provided to the server(s) 130 and used to associate the request with a specific user’s profile which may include any number of user preferences that may dictate how the report 16’ is to be generated. For example, the customer ID encoded in the barcode 18 may determine a skill level of the user and/or user preferences that inform the server(s) 130 on how to appropriately tailor the complexity of the diagnostic report 16’. The user profile may be created at the same store where the vehicle 10 is scanned using the diagnostic tool 110 (and the initial report 16 generated), for example, or at a website associated with the store.

By encoding the preferred retailer, customer ID, and/or any other preferences and settings in the barcode 18 itself, the system 100 may make it possible to produce appropriately customized reports 16’ even for users that do not scan the barcode 18 using a specific dedicated app. The barcode 18 may be scanned and the report 16’ generated (e.g., via customized URL) using only a native web browser and camera functionality of a smartphone or other handheld computing device 140. Along these lines, it is contemplated that the customized URL may itself link to a mobile app store where one or more relevant apps may be downloaded. At a later time, if the same barcode 18 is scanned after the app has been downloaded on the handheld computing device 140, the customized URL may deep-link to the relevant page of the mobile app instead of generating the customized webpage.

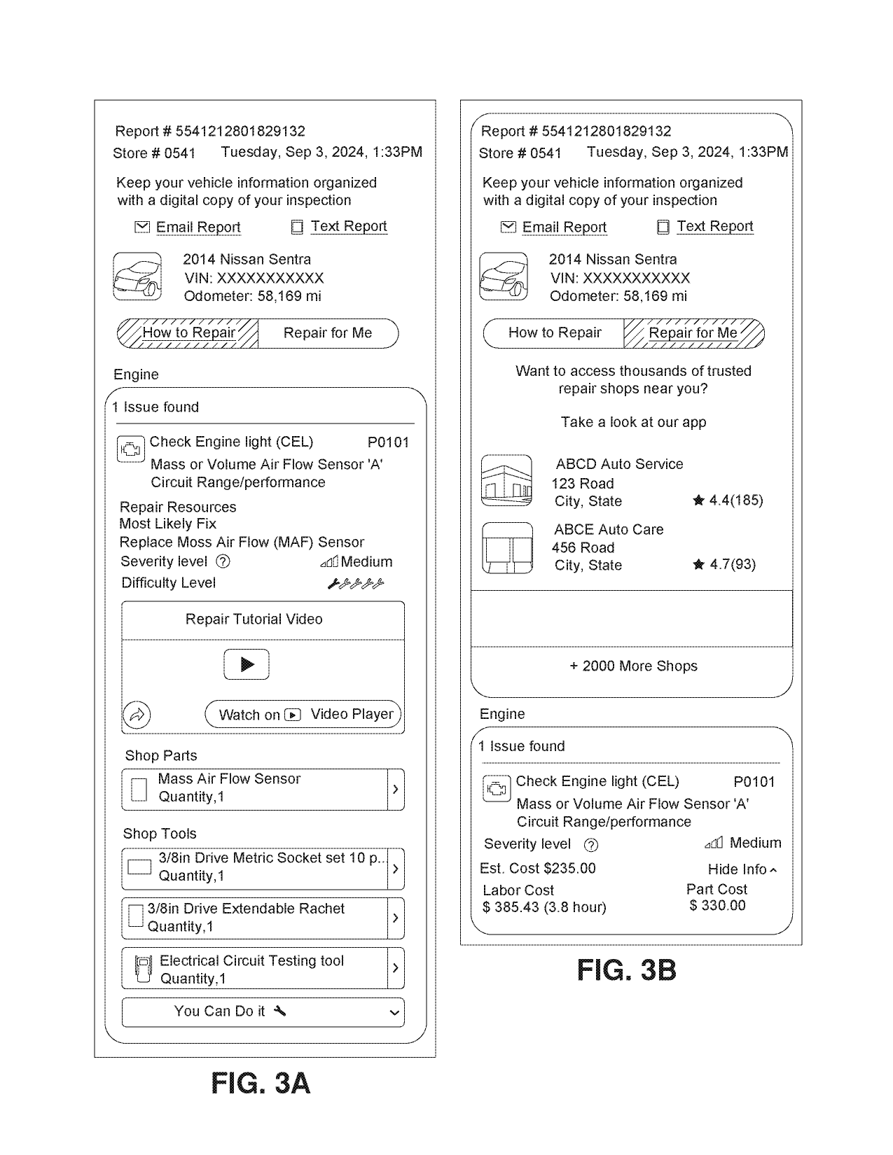

FIGS. 3A and 3B show example webpages (or app pages) generated by the system 100. FIG. 3A shows a “do-it-yourself” (DIY) webpage, while FIG. 3B shows a “do-it-for-me” (DIFM) webpage. In the illustrated example, the user is able to freely toggle between the DIY webpage and the DIFM webpage by clicking “How to Repair” (for the DIY webpage) and “Repair for Me” (for the DIFM webpage). Individually, or collectively (e.g., using a toggle switch), the webpages of FIGS. 3A and 3B may be an example of the customized report 16’ described herein, which may be accessed by scanning the barcode 18 (e.g., via a URL as described herein). As can be seen, both versions of the report 16’ are generated from the same underlying diagnostic data, which may be collected using the diagnostic tool 110 as described in relation to FIG. 1. In both versions, the same issue is found, namely, diagnostic trouble code P0101 associated with a bad mass or volume air flow sensor. In the DIY example of FIG. 3A, the user is presented with the difficulty level of the repair (to assist the user in determining whether to do the repair him/herself), an instructional video that demonstrates how to do the repair, and links to buy necessary parts (e.g., a mass air flow sensor) and tools. In contrast, the DIFM example of FIG. 3B omits the difficult level and the links to parts and tools, instead displaying nearby auto service centers where the repair can be made by a professional. Advantageously, in addition to encoding the user’s preferences (which may set a default display to DIY or DIFM, for example), the barcode 18 may encode preferred providers of parts, tools, and repair services as described above, making it possible for the business that performed the diagnostic scan to retain the customer or drive business to an affiliate, for example.

In the example webpages of FIGS. 3A and 3B, it is contemplated that the various parts, tools, and repair services may be displayed with relevant pricing and availability information. Along the same lines, displayed parts, tools, and repair services may preferably include links to the relevant e-commerce or service scheduling sites of the preferred retailer or other provider, preferably deep-linking the user to the specific item in question (e.g., a “Buy Now” link). To this end, the system 100 (specifically, the remote server(s) 130) may call an application programming interface (API) to query the part/tool/service provider for inventory data or a relevant URL. For example, the remote server(s) 130 may call an API to convert a universal part number or other general identifier of the item into the provider’s own specific URL where the item can be purchased or reserved. In this way, the report 16’ may seamlessly link the user to various affiliate e-commerce or service scheduling sites without it being necessary for the server(s) 130 to store and update proprietary internal information of each provider.

In the various examples discussed above, the barcode 18 is described as being included in a printed report 16. However, the disclosed subject matter is not limited to printed barcodes 18 but may also encompass barcodes 18 that are displayed on-screen, such as in a copy of the report 16 that is displayed on a display screen of the diagnostic tool 110. In this case, the user may immediately capture the barcode 18 after the completion of the diagnostic scan by the diagnostic tool 110 and may subsequently communicate with the remote server(s) 130 to generate one or more customized scans 16’ as described herein.

The functionality described above in relation to the diagnostic tool 110, store computer 120, server(s) 130, 132, and handheld computing device 140 shown in FIG. 1, as well as the operational flows described in relation to FIG. 2 and throughout the disclosure, may be wholly or partly embodied in one or more computers including a processor (e.g. a CPU), a system memory (e.g. RAM), and a hard drive or other secondary storage device. The processor may execute one or more computer programs, which may be tangibly embodied along with an operating system in a computer-readable medium, e.g., the secondary storage device. The operating system and computer programs may be loaded from the secondary storage device into the system memory to be executed by the processor. The computer may further include a network interface for network communication between the computer and external devices (e.g., over the Internet), such as between the store computer 120 and the server(s) 130, between the black box unit 132 and the server(s) 130, or between the handheld computing device 140 and the server(s) 130. To the extent that any of the described functionality may be performed by the server(s) 130, the server(s) 130 may comprise multiple physical servers and other computers that communicate with each other to perform the described functionality.

The above computer programs may comprise program instructions which, when executed by the processor, cause the processor to perform operations in accordance with the various embodiments of the present disclosure. The computer programs may be provided to the secondary storage by or otherwise reside on an external computer-readable medium such as a DVD-ROM, an optical recording medium such as a CD or Blu-ray Disk, a magneto-optic recording medium such as an MO, a semiconductor memory such as an IC card, a tape medium, a mechanically encoded medium such as a punch card, etc. Other examples of computer-readable media that may store programs in relation to the disclosed embodiments include a RAM or hard disk in a server system connected to a communication network such as a dedicated network or the Internet, with the program being provided to the computer via the network. Such program storage media may, in some embodiments, be non-transitory, thus excluding transitory signals per se, such as radio waves or other electromagnetic waves. Examples of program instructions stored on a computer-readable medium may include, in addition to code executable by a processor, state information for execution by programmable circuitry such as a field-programmable gate arrays (FPGA) or programmable logic array (PLA).

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method of enabling continued access to a vehicle-specific diagnostic data package after a diagnostic report is generated using the diagnostic data package, the process comprising:
receiving a vehicle diagnostic data package generated from a scan of a specific vehicle at a first location;
appending a unique identifier to the diagnostic data package;
communicating the diagnostic data package with the appended unique identifier to one or more servers where the diagnostic data package can be stored at a location indexable by the unique identifier, the one or more servers being configured to process the diagnostic data package to generate a diagnostic report identifying vehicle conditions associated with the specific vehicle and the received diagnostic data package; and
producing a copy of the diagnostic report at the first location, the copy of the diagnostic report including a barcode representative of the location where the diagnostic data package is stored on the one or more servers and further representative of at least one provider of automotive parts or repair services identified in the diagnostic report, the barcode being scannable by a handheld computing device to enable access to the diagnostic data package and identification of the at least one provider.

2. The method of claim 1, wherein the barcode includes indicia representative of the unique identifier.

3. The method of claim 1, wherein, upon accessing the diagnostic data package on the one or more servers using the handheld computing device, a user may direct the one or more servers to regenerate the diagnostic report.

4. The method of claim 1, wherein, upon accessing the diagnostic data package on the one or more servers using the handheld computing device, a user may direct the one or more servers to identify parts needed to address vehicle conditions in the diagnostic report.

5. The method of claim 1, wherein, upon accessing the diagnostic data package on the one or more servers using the handheld computing device, a user may direct the one or more servers to generate a customized diagnostic report.

6. The method of claim 5, wherein the customized diagnostic report is customized based on environmental data associated with the handheld computing device.

7. The method of claim 6, wherein the environmental data includes a time or date at which the diagnostic data package is accessed using the handheld computing device.

8. The method of claim 6, wherein the environmental data includes a location at which the diagnostic data package is accessed using the handheld computing device.

9. The method of claim 6, wherein the environmental data includes an identity of a mobile application installed on the handheld computing device.

10. The method of claim 5, wherein the customized diagnostic report is customized based on an identity of the user.

11. The method of claim 10, wherein the customized diagnostic report is customized based on a skill level of the user.

12. The method of claim 10, wherein the customized diagnostic report is customized based on a user preference.

13. The method of claim 1, wherein the one or more servers comprises a remote server at a location remote from the first location, the diagnostic data package and appended unique identifier being communicated to the remote server via the Internet.

14. The method of claim 1, wherein the one or more servers comprises a local server at the first location.

15. A computer program product comprising one or more non-transitory program storage media on which are stored instructions executable by one or more processors or programmable circuits to perform operations for enabling continued access to a vehicle-specific diagnostic data package after a diagnostic report is generated using the diagnostic data package, the operations comprising:
receiving a vehicle diagnostic data package generated from a scan of a specific vehicle at a first location;
appending a unique identifier to the diagnostic data package;
communicating the diagnostic data package with the appended unique identifier to one or more servers where the diagnostic data package can be stored at a location indexable by the unique identifier, the one or more servers being configured to process the diagnostic data package to generate a diagnostic report identifying vehicle conditions associated with the specific vehicle and the received diagnostic data package; and
producing a copy of the diagnostic report at the first location, the copy of the diagnostic report including a barcode representative of the location where the diagnostic data package is stored on the one or more servers and further representative of at least one provider of automotive parts or repair services identified in the diagnostic report, the barcode being scannable by a handheld computing device to enable access to the diagnostic data package and identification of the at least one provider.

16. The computer program product of claim 15, wherein the one or more servers comprises a remote server at a location remote from the first location, the diagnostic data package and appended unique identifier being communicated to the remote server via the Internet.

17. The computer program product of claim 15, wherein the one or more servers comprises a local server at the first location.

18. A system for enabling continued access to a vehicle-specific diagnostic data package after a diagnostic report is generated using the diagnostic data package, the system comprising:
a computer configured to receive a vehicle diagnostic data package generated from a scan of a specific vehicle at a first location, append a unique identifier to the diagnostic data package, communicate the diagnostic data package with the appended unique identifier to one or more servers where the diagnostic data package can be stored at a location indexable by the unique identifier, and produce a copy of a diagnostic report at the first location, the diagnostic report being generated by the one or more servers based on the diagnostic data package and identifying vehicle conditions associated with the specific vehicle; and
a handheld computing device configured to scan a barcode included in the copy of the diagnostic report, the barcode being representative of the location where the diagnostic data package is stored on the one or more servers and further representative of at least one provider of automotive parts or repair services identified in the diagnostic report, the barcode being scannable by a handheld computing device to enable access to the diagnostic data package and identification of the at least one provider.

19. The system of claim 18, wherein the one or more servers comprises a remote server at a location remote from the first location, the diagnostic data package and appended unique identifier being communicated to the remote server via the Internet.

20. The system of claim 18, wherein the one or more servers comprises a local server at the first location.
